(19) United States
(12) Patent Application Publication
(10) Pub. No.: US 2017/0336191 A1
(43) Pub. Date: Nov. 23, 2017

(54) ADDITIVE MANUFACTURE WITH MAGNETIC IMPRINT

(71) Applicants: John C. Welch, Spring, TX (US); Zhiyue Xu, Cypress, TX (US)

(72) Inventors: John C. Welch, Spring, TX (US); Zhiyue Xu, Cypress, TX (US)

(73) Assignee: Baker Hughes Incorporated, Houston, TX (US)

(21) Appl. No.: 15/160,056

(22) Filed: May 20, 2016

(51) Int. Cl. G01B 7/30; B22F 3/105; B22F 5/00; B33Y 80/00; B33Y 30/00; B33Y 10/00

(52) U.S. Cl. CPC G01B 7/30; B22F 3/1055; B22F 5/00; B33Y 30/00; B33Y 10/00; B33Y 80/00

(57) ABSTRACT

A method of manufacturing an article comprises depositing a layering material on a substrate or a worktable; applying a magnetic field to the layering material according to a preset pattern; and additively forming the article.

### BACKGROUND

Additive manufacturing involves depositing or building a part or article layer-by-layer. By using a layer-by-layer approach, pieces that used to be molded separately and then assembled can be produced as one piece. Additive manufacturing also allows the manufacture of parts and products having complex and unique architectures. Various additive manufacturing processes have been proposed to make articles and components for a wide range of industries such as automotive, aerospace, consumer electronics, healthcare, and oil and gas industries. Despite all the advances, there is still a need in the art for an alternative method and apparatus for additive manufacturing, in particular a method and apparatus that can produce articles having varying magnetic, thermal, or electrical properties.

### BRIEF DESCRIPTION

A method of manufacturing an article comprises depositing a layering material on a substrate or a worktable; applying a magnetic field to the layering material according to a preset pattern; and additively forming the article.

In another embodiment, an article comprises an additively fused layering material comprising one or more of the following: a metal; a metal oxide; a metal alloy; a ceramic; or a composite material, wherein about 10 wt. % to about 50 wt. % of the layering material is a magnetic material having a Curie temperature of greater than about 200° F.

A method of using an article comprises: depositing a layering material on a substrate or a worktable; applying a magnetic field to the layering material according to a preset pattern; additively forming the article, the article comprising a magnetic mark; and detecting the magnetic mark.

An apparatus of manufacturing an article comprises a source of a layering material; an energy source configured to emit an energy beam; a magnetic field source effective to generate a magnetic field; and a processor configured to control the magnetic field source such that the magnetic field is varied according to a preset pattern.

### BRIEF DESCRIPTION OF THE DRAWINGS

Referring now to the drawings wherein like elements are numbered alike in the several Figures:

FIG. 1 depicts a partial system and apparatus for manufacturing an article according to an embodiment of the disclosure;

FIG. 2 depicts a partial system and apparatus for manufacturing an article according to another embodiment of the disclosure;

FIG. 3 depicts a partial system and apparatus for manufacturing an article according to yet another embodiment of the disclosure;

FIG. 4 is a side-view of an article with magnetized areas forming a bar code; and

FIG. 5 illustrates the alignment of a pipe having a magnetic mark and a tool with sensing coils and circuitry that can detect the magnetic mark in the pipe.

### DETAILED DESCRIPTION

Disclosed herein are additive manufacturing methods and apparatus effective to produce articles having varying magnetic, thermal, or electrical properties. During an additive manufacturing process to make the articles, a magnetic field is applied to a layering material when the material is heated to a temperature above its Curie temperature. By turning on and off the magnetic field, varying the direction of the magnetic field, or varying the strength of the magnetic field, the manufactured articles can have different magnetic, thermal, or electrical properties at different portions of the articles. When the layering material is cooled down, the magnetic, thermal, or electrical properties are “frozen” and remain unchanged after the magnetic field is removed.

An apparatus of manufacturing an article comprises a source of a layering material; an energy source configured to emit an energy beam; a magnetic field source effective to generate a magnetic field; and a processor configured to control the magnetic field source such that the magnetic field is varied according to a preset pattern.

The layering material comprises a metal, a metal oxide, a metal alloy, a ceramic, a composite material, or a combination comprising at least one of the foregoing. In particular, the layering material comprises a magnetic material, which can be a ferromagnetic material, a paramagnetic material, or a combination thereof. In an embodiment, the layering material comprises a magnetic material having a Curie temperature of greater than about 200° F., greater than about 300° F., or greater than about 350° F. Illustratively magnetic materials include but are not limited to iron, nickel, cobalt, ferrite, steel, platinum, and aluminum. In some embodiment one hundred percent of the layering material is a magnetic material. In other embodiments, about 0.5 wt. % to less than 100 wt. %, about 5 wt. % to about 95 wt. %, about 10 wt. % to about 50 wt. %, or about 15 wt. % to about 25 wt. % of the layering material is a magnetic material.

The layering material can be in the form of a powder or a wire. In an exemplary embodiment, the layering material is a powder comprising particles having an average particle size of about 5 μm to about 300 μm, more particularly about 80 μm to about 120 μm, and even more particularly about 100 μm.

The layering material can be delivered from a reservoir via a nozzle or dispenser either in the presence or in the absence of a flowable medium such as argon, nitrogen, or air. The layering material can also be distributed from a powder bed having a movable delivery column using a distributor such as a roller or pusher. In an embodiment, the nozzle or dispenser is configured to supply the layering material coaxially with the energy beam.

The energy source may include a focused heat source of sufficient power to heat the layering material above its Curie temperature. In some embodiments, the energy source at least partially melts the layering material. The focused heat source may be, for example, an ytterbium-fiber optic laser, a carbon dioxide laser, or an electron beam emitter. A power rating of the focused heat source may be, for example, about 150 Watts or more. More specifically, the power rating of the focused heat source (e.g., the maximum power consumed by the focused heat source during operation) may be, for example, about 200 Watts or more.

To produce articles having different magnetic, thermal, or electrical properties at different portions of the articles, the apparatus also includes a magnetic field source. The magnetic field source can be an electromagnet. Electromagnets include closely spaced turns of wire such as coils. When connected to a power supply or current source, the electromagnet becomes energized, creating a magnetic field. The magnetic field disappears when the current is turned off. The wire turns can optionally wound around a magnetic core made of a ferromagnetic or ferromagnetic material such as iron. The magnetic core concentrates the magnetic flux and makes a more powerful magnet.

The magnetic field source can be movable. For example, the magnetic field source can be configured to move along with the energy beam. The moving direction of magnetic field source is not particularly limited as long as the generated magnetic field can be effectively applied to the layering material after it is heated to a temperature above its Curie temperature. In an embodiment, the magnetic field source and the energy source are configured to move in a parallel manner. Alternatively, the magnetic field source is stationary, and the direction of the energy beam is controlled by a scanning mirror.

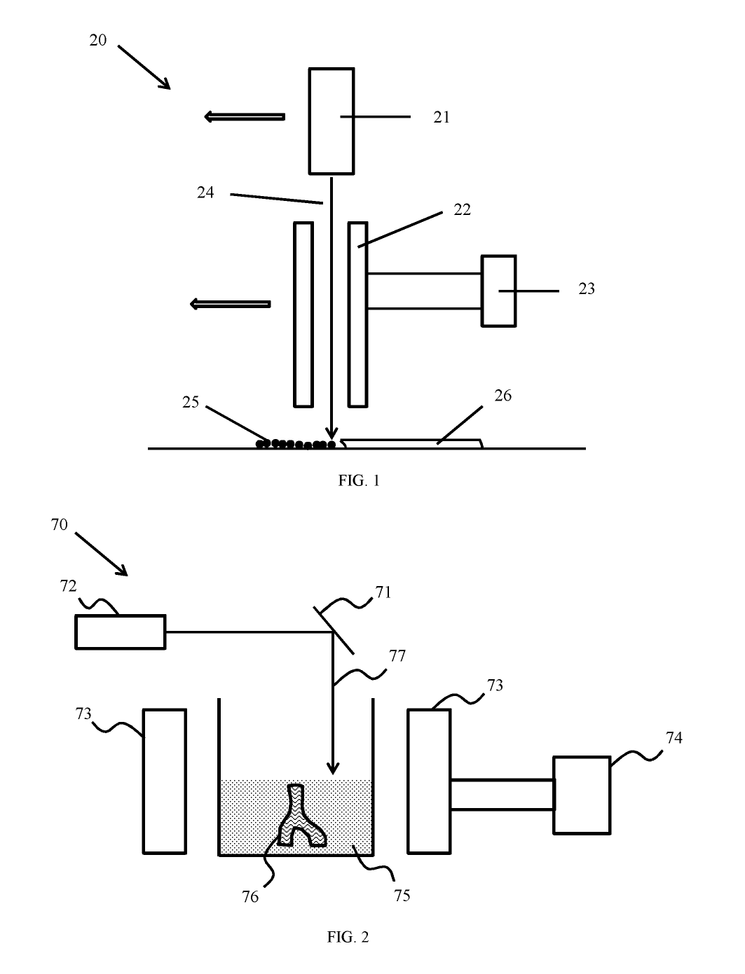

FIG. 1 depicts an exemplary partial system and apparatus 20 for manufacturing an article. In FIG. 1, electromagnet 22 is connected to power supply 23 and is effective to generate a magnetic field. The electromagnet is positioned close to the energy source 21 and is configured to move along with the energy source so that the a magnetic field can be applied to layering material 25 while energy beam 24 heats the layering material 25 above its Curie temperature. The layering material can be fused to form layer 26 having controlled magnetic properties, control thermal conductivity, or controlled electrical conductivity.

FIG. 2 depicts another an exemplary partial system and apparatus 70 for manufacturing an article. In FIG. 2, electromagnet 73 is connected to power supply 74 and is effective to generate a magnetic field. An energy source 72 generates energy beam 77 which is applied to powder 75 according to a preset pattern forming part 76. Both the energy source 72 and the magnetic field source 73 are stationary. The direction of energy beam 77 is controlled by scanning mirror 71.

The magnetic field can be turned on and off by connecting or disconnecting the wire turns or coils with a power supply or current source. The direction of the magnetic field can be varied by changing the position of the electromagnet or changing the direction of the current flow through the coils. The strength of the magnetic field can be adjusted by moving the magnetic source closer or away from the heated layering material or by increasing or decreasing the current flowing through the coils.

The variation of the magnetic field can be controlled by a processor according to a preset pattern. The processer can be a desktop or laptop computer connected to the magnetic field source. The processer can also be connected to the energy source to synchronize the movement of the energy source and the magnetic field source, in the event that both the magnetic field source and the energy source are movable.

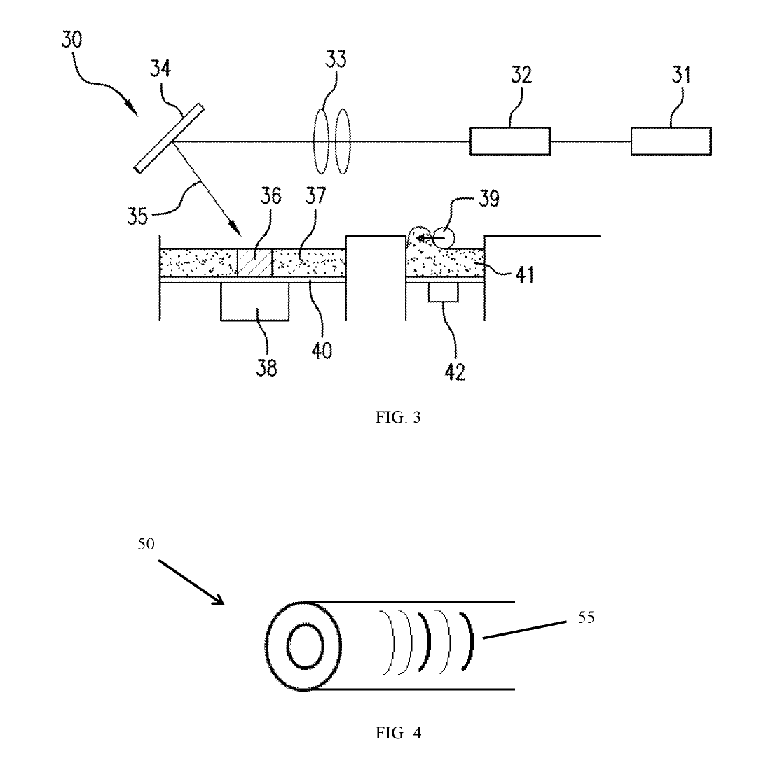

Another exemplary system for performing an additive process to manufacture articles is shown in FIG. 3. Although a magnetic field source is not shown in FIG. 3, it is appreciated an electromagnet can be disposed adjacent the worktable 40. A manufacturing system 30 for performing a manufacturing process includes a processing device 31 (e.g., a desktop or laptop computer) connected to an energy source such as laser 32. The processing device includes suitable software to control the laser 32 based on an inputted design. The design may be created by a user using software, such as a computer aided design (CAD) program, stored in the processing device 31, or the design may be input from a different device.

The processing device 31 directs the laser to emit a beam 35, and steers or otherwise controls the beam using, e.g., lenses 33 and a scanning mirror 34. The beam 35 is applied to a layering material 37 disposed on a building platform or worktable 40 to successively form layers that build an article 36. A supply device 41 may be utilized to supply layering material to the building platform through a roller 39. Although not shown, it is appreciated that more than one supply device can be present. At least one of the building platform and the supply device is configured to move along a direction perpendicular to the platform or supply device by guide rails 38 and 42. Other similar arrangements can also be used such that one or both of the platform and supply device are moveable relative to each other. The build platform can be isolated or exposed to atmospheric conditions.

The apparatus can be used to manufacture article having one or more of the following varied properties: magnetic property; thermal conductivity; or electrical conductivity. A method of manufacturing an article comprises: depositing a layering material on a substrate or a worktable; applying a magnetic field to the layering material according to a preset pattern; and additively forming the article.

Additively forming can be part of any additive manufacturing process, provided that the process allows the depositing of at least one layer of a layering material upon a substrate or worktable, heating the layering material above its Curie temperature, forming a fused layer, and repeating these operations until an article is made. Exemplary additive manufacturing process includes micro-plasma powder deposition, selective laser melting, direct metal laser sintering, selective laser sintering, electron beam melting, as well as electron beam freeform fabrication. Additional techniques including without limitation direct laser deposition, cold gas processing, laser cladding, direct material deposition, ceramic additive manufacturing, or binder jetting and subsequent sintering.

In some embodiments, a plurality of layers is formed by an additive manufacturing process. “Plurality” as used in the context of additive manufacturing includes 20 or more layers. The maximum number of layers can vary greatly, determined, for example, by considerations such as the size of the article being manufactured, the technique used, the capabilities of the equipment used, and the level of detail desired in the final article. For example, 20 to 100,000 layers can be formed, or 50 to 50,000 layers can be formed.

As used herein, “layer” is a term of convenience that includes any shape, regular or irregular, having at least a predetermined thickness. In some embodiments, the size and configuration of two dimensions are predetermined, and on some embodiments, the size and shape of all three dimensions of the layer is predetermined. The thickness of each layer can vary widely depending on the additive manufacturing method. In some embodiments the thickness of each layer as formed differs from a previous or subsequent layer. In some embodiments, the thickness of each layer is the same. In some embodiments the thickness of each layer as formed is about 0.1 millimeters (mm) to about 10 mm or about 0.5 mm to about 5 mm.

In some embodiments, additive manufacturing can occur by depositing as a sequence of layers on a substrate or a worktable, in an x-y plane. These deposited layers are fused together using an energy beam from an energy source. The position of a layering material supply device relative to the platform or substrate is then moved along a z-axis (perpendicular to the x-y plane), and the process is then repeated to form a 3D article resembling a digital representation of the article. Alternatively, the substrate or worktable is configured to move in an x-y plane and the layering material supply device is configured to move along a z-axis.

The method further comprises heating the layering material to a temperature above the Curie temperature of the layering material while applying the magnetic field to the layering material. The layering material can be fused. In an embodiment, the layering material is at least partially fused before deposited on the substrate or the worktable. In another embodiment, the layering material is fused after deposited on the substrate or the worktable. Fusing the layering material comprises applying an energy beam from an energy source to the layering material.

A system (e.g., the system of FIGS. 1-3) can be used to additively form the article from the layering material by using an energy beam to heat the layering material and form successive layers. Each layer is formed on the immediately preceding layer until the structure is complete.

When the article has gradient properties, the method further comprises applying a magnetic field to the layering material according to a preset pattern. Changing the magnetic field includes turning on and off the magnetic field, changing the direction of the magnetic field, changing the intensity of the magnetic field, or a combination thereof. The strength of the magnetic field can be varied by changing an intensity of an electric current passes through the wire turns or adjusting the relative distance of the magnetic field source to the heated layering material. The direction of the magnetic field can be varied by changing the direction of the current flows through the wire turns or by changing the position of the electromagnet. Preferably, the magnetic field is turned on and off by connecting or disconnecting electromagnets to a power or current source.

The method further includes acquiring, generating and/or creating a design for the article. The design may be defined by the size and shape of the article, magnetic field profile, material density, fusing energy profile or composition profile of the layering material to achieve the varied magnetic, electric, or thermal properties. For example, a design may be generated that features articles having a selected magnetic mark at one location of the article. A design can also be generated to form articles having random magnetic properties.

Using the above processes, an article having controlled magnetic, thermal or electrical properties at different locations can be formed. The article can be, but is not limited to, a downhole article.

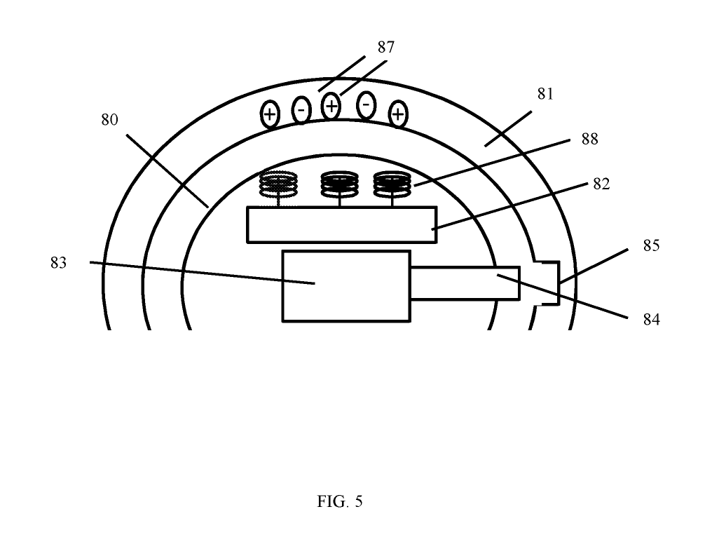

An exemplary article prepared from a method disclosed herein is illustrated in FIG. 4. As shown in FIG. 4, the article 50 has a magnetic mark 55. The magnetic mark can provide identification information for the part. Any other useful information can also be created and stored in the magnetic mark. The magnetic marks can be detected and read by magnetic sensors known in the art.

The magnetic marks can also be used for aligning parts and for verifying engagement/disengagement. As shown in FIG. 5, pipe 81 is made from a process as disclosed herein. Pipe 81 comprises a magnetic mark 87 and a keyway 85. A second tool 82 comprises sensing coils 88 and sensing and control circuit 82 that are effective to detect magnetic marks, and a plunger 84. Tool 82 is connected to an actuator 83, which can move tool 83 inside pipe 81. Once a matching magnetic mark is detected, tool 82 can be coupled to pipe 81.

In some embodiments, the articles made by the processes disclosed herein have random magnetic orientations throughout the articles. Such articles are not susceptible to magnetization and can be used in the cover or housing of sensitive electronics.

Set forth below are various embodiments of the disclosure.

Embodiment 1. A method of manufacturing an article, the method comprising: depositing a layering material on a substrate or a worktable; applying a magnetic field to the layering material according to a preset pattern; and additively forming the article.

Embodiment 2. The method of Embodiment 1, further comprising heating the layering material to a temperature above the Curie temperature of the layering material while applying the magnetic field to the layering material.

Embodiment 3. The method of Embodiment 1 or Embodiment 2, wherein the layering material comprises one or more of the following: a metal; a metal oxide; a metal alloy; a ceramic; or a composite material.

Embodiment 4. The method of any one of Embodiments 1 to 3, wherein the layering material comprises a magnetic material having a Curie temperature of greater than about 200° F.

Embodiment 5. The method of any one of Embodiments 1 to 4, wherein the layering material comprises a magnetic material having a Curie temperature of greater than about 300° F.

Embodiment 6. The method of any one of Embodiments 1 to 5, further comprising generating a magnetic field through a magnetic field source.

Embodiment 7. The method of Embodiment 6, wherein the magnetic field source comprises an electromagnet.

Embodiment 8. The method of Embodiment 6, further comprising fusing the layering material.

Embodiment 9. The method of Embodiment 8, wherein the layering material is at least partially fused before deposited on the substrate or the worktable.

Embodiment 10. The method of Embodiment 8, wherein the layering material is fused after deposited on the substrate or the worktable.

Embodiment 11. The method of Embodiment 9 or Embodiment 10, wherein fusing the layering material comprises applying an energy beam from an energy source to the layering material.

Embodiment 12. The method of Embodiment 11, wherein the energy source is configured to move along with the magnetic field source.

Embodiment 13. The method of Embodiment 11, wherein the energy source and the magnetic field source are stationary, and the direction of the energy beam is varied.

Embodiment 14. The method of any one of Embodiments 1 to 13, further comprising varying the magnetic field by one or more of the following: turning on and off the magnetic field; varying the direction of the magnetic field; or varying the strength of the magnetic field.

Embodiment 15. The method of any one of Embodiments 1 to 14, wherein the article has one or more of the following varied properties: magnetic property; thermal conductivity; or electrical conductivity.

Embodiment 16. An article comprising an additively fused layering material comprising one or more of the following: a metal; a metal oxide; a metal alloy; a ceramic; or a composite material, wherein about 10 wt. % to about 50 wt. % of the layering material is a magnetic material having a Curie temperature of greater than about 200° F.

Embodiment 17. The article of Embodiment 16, wherein the article is a downhole article.

Embodiment 18. The article of Embodiment 16 or Embodiment 17, wherein the article has information stored in a magnetic mark.

Embodiment 19. The article of Embodiment 16 or Embodiment 17, wherein the article has random magnetic orientations throughout the article.

Embodiment 20. A method of using an article, the method comprising: depositing a layering material on a substrate or a worktable; applying a magnetic field to the layering material according to a preset pattern; additively forming the article, the article comprising a magnetic mark; and detecting the magnetic mark.

Embodiment 21. The method of Embodiment 20, wherein detecting the magnetic mark comprises detecting the location of the magnetic mark, detecting the information stored in the magnetic mark, or a combination thereof.

Embodiment 22. The method of Embodiment 20 or Embodiment 21, further comprising aligning a second article with the article, the second article comprising a sensing element effective to detect the magnetic mark of the article.

Embodiment 23. An apparatus of manufacturing an article, the apparatus comprising: a source of a layering material; an energy source configured to emit an energy beam; a magnetic field source effective to generate a magnetic field; and a processor configured to control the magnetic field source such that the magnetic field is varied according to a preset pattern.

Embodiment 24. The apparatus of Embodiment 23, wherein controlling the magnetic field source comprises controlling the magnetic field source to turn on and off the magnetic field; to vary the direction of the magnetic field; to vary the strength of the magnetic field; or a combination comprising at least one of the foregoing.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A method of manufacturing an article, the method comprising:
depositing a layering material on a substrate or a worktable;
applying a magnetic field to the layering material according to a preset pattern; and
additively forming the article.

2. The method of claim 1, further comprising heating the layering material to a temperature above the Curie temperature of the layering material while applying the magnetic field to the layering material.

3. The method of claim 2, wherein the layering material comprises one or more of the following: a metal; a metal oxide; a metal alloy; a ceramic; or a composite material.

4. The method of claim 2, wherein the layering material comprises a magnetic material having a Curie temperature of greater than about 200° F.

5. The method of claim 2, wherein the layering material comprises a magnetic material having a Curie temperature of greater than about 300° F.

6. The method of claim 1, further comprising generating a magnetic field through a magnetic field source.

7. The method of claim 6, wherein the magnetic field source comprises an electromagnet.

8. The method of claim 6, further comprising fusing the layering material.

9. The method of claim 8, wherein the layering material is at least partially fused before deposited on the substrate or the worktable.

10. The method of claim 8, wherein the layering material is fused after deposited on the substrate or the worktable.

11. The method of claim 8, wherein fusing the layering material comprises applying an energy beam from an energy source to the layering material.

12. The method of claim 11, wherein the energy source is configured to move along with the magnetic field source.

13. The method of claim 11, wherein the energy source and the magnetic field source are stationary, and the direction of the energy beam is varied.

14. The method of claim 1, further comprising varying the magnetic field by one or more of the following: turning on and off the magnetic field; varying the direction of the magnetic field; or varying the strength of the magnetic field.

15. The method of claim 1, wherein the article has one or more of the following varied properties: magnetic property; thermal conductivity; or electrical conductivity.

16. An article comprising an additively fused layering material comprising one or more of the following: a metal; a metal oxide; a metal alloy; a ceramic; or a composite material, wherein about 10 wt. % to about 50 wt. % of the layering material is a magnetic material having a Curie temperature of greater than about 200° F.

17. The article of claim 16, wherein the article is a downhole article.

18. The article of claim 16, wherein the article has information stored in a magnetic mark.

19. The article of claim 16, wherein the article has random magnetic orientations throughout the article.

20. A method of using an article, the method comprising:
depositing a layering material on a substrate or a worktable;
applying a magnetic field to the layering material according to a preset pattern;
additively forming the article, the article comprising a magnetic mark; and
detecting the magnetic mark.

21. The method of claim 20, wherein detecting the magnetic mark comprises detecting the location of the magnetic mark, detecting the information stored in the magnetic mark, or a combination thereof.

22. The method of claim 20, further comprising aligning a second article with the article, the second article comprising a sensing element effective to detect the magnetic mark of the article.

23. An apparatus of manufacturing an article, the apparatus comprising:
a source of a layering material;
an energy source configured to emit an energy beam;
a magnetic field source effective to generate a magnetic field; and
a processor configured to control the magnetic field source such that the magnetic field is varied according to a preset pattern.

24. The apparatus of claim 23, wherein controlling the magnetic field source comprises controlling the magnetic field source to turn on and off the magnetic field; to vary the direction of the magnetic field; to vary the strength of the magnetic field; or a combination comprising at least one of the foregoing.
